(19) United States
(12) Patent Application Publication
(10) Pub. No.: US 2016/0284383 A1
(43) Pub. Date: Sep. 29, 2016

(54) CONTROL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Masato Kozakura, Tokyo (JP)

(21) Appl. No.: 15/077,119

(22) Filed: Mar. 22, 2016

(30) Foreign Application Priority Data
Mar. 24, 2015 (JP) 2015-061666

(51) Int. Cl. G11B 27/34; G06F 3/041; H04N 9/87; G06F 3/0488

(52) U.S. Cl. CPC G11B 27/34; G06F 3/04883; G06F 3/041; H04N 9/87

(57) ABSTRACT

A timeline indicating image capture periods of recorded videos captured by a plurality of image capturing devices, as well as a movie that is decided on in accordance with an operation on the timeline, is displayed on a display screen. An operation on the display screen is accepted. When the operation on the display screen accepted during display of a first movie captured by a first image capturing device included among the plurality of image capturing devices indicates a predetermined direction different from a time direction of the timeline, the movie displayed on the display screen is switched from the first movie to a second movie captured by a second image capturing device.

### BACKGROUND OF THE INVENTION

1. Field of the Invention

The present invention relates to a movie playback technique.

2. Description of the Related Art

An image display apparatus connected to a recording apparatus can control a camera that captures a movie, and play back a recorded movie. Therefore, the image display apparatus supports protocols for controlling the recording apparatus and protocols for controlling the camera.

In order to present information of a recorded movie to a user, the image display apparatus may provide a user interface called a timeline, which is a colored chronological graph indicating a time slot in which recording was performed. As a time scale of the timeline can be arbitrarily changed, such a time slot in which recording was performed can be indicated by the timeline on a day-to-day basis, on a minute-to-minute basis, or the like. By selecting a bar indicating the presence of recorded data on the timeline, the recorded data can be played back and displayed from the designated time. A display area and a timeline for different cameras can be allocated to a display area of the image display apparatus to enable switching from a movie recorded by one camera to a movie recorded by another camera.

Patent Document 1 (Japanese Patent Laid-Open No. 2013-17173) discloses a technique related to an image display apparatus that connects to a recording apparatus to enable viewing of a recorded movie, and a method of presenting a plurality of pieces of data recorded by a plurality of cameras on a single timeline by displaying bars indicating recording information on the timeline using different colors for different cameras.

The technique disclosed in Patent Document 1 requires a separate configuration for selecting a camera or movie data. Specifically, it requires a user interface, such as a list box and a menu, to be prepared separately. However, with this method, a display area could possibly be constrained.

### SUMMARY OF THE INVENTION

The present invention has been made in view of the above problems, and provides a technique to allow a user to issue an instruction for playing back an arbitrary movie among a plurality of movies more easily.

According to the first aspect of the present invention, there is provided a control apparatus, comprising: a display control unit configured to control to display a timeline and a movie on a display screen, the timeline indicating image capture periods of recorded videos captured by a plurality of image capturing devices, and the movie being decided on in accordance with an operation on the timeline; an accepting unit configured to accept an operation on the display screen; and a switching unit configured to, when the operation on the display screen accepted by the accepting unit during display of a first movie captured by a first image capturing device included among the plurality of image capturing devices indicates a predetermined direction different from a time direction of the timeline, switch the movie displayed on the display screen from the first movie to a second movie captured by a second image capturing device.

According to the second aspect of the present invention, there is provided a control method, comprising: controlling to display a timeline and a movie on a display screen, the timeline indicating image capture periods of recorded videos captured by a plurality of image capturing devices, and the movie being decided on in accordance with an operation on the timeline; accepting an operation on the display screen; and when the operation on the display screen accepted during display of a first movie captured by a first image capturing device included among the plurality of image capturing devices indicates a predetermined direction different from a time direction of the timeline, switching the movie displayed on the display screen from the first movie to a second movie captured by a second image capturing device.

According to the third aspect of the present invention, there is provided a non-transitory computer-readable storage medium storing a computer program for causing a computer to function as: a display control unit configured to control to display a timeline and a movie on a display screen, the timeline indicating image capture periods of recorded videos captured by a plurality of image capturing devices, and the movie being decided on in accordance with an operation on the timeline; an accepting unit configured to accept an operation on the display screen; and a switching unit configured to, when the operation on the display screen accepted by the accepting unit during display of a first movie captured by a first image capturing device included among the plurality of image capturing devices indicates a predetermined direction different from a time direction of the timeline, switch the movie displayed on the display screen from the first movie to a second movie captured by a second image capturing device.

Further features of the present invention will become apparent from the following description of exemplary embodiments (with reference to the attached drawings).

### BRIEF DESCRIPTION OF THE DRAWINGS

FIG. 1 is a block diagram showing an example of a configuration of a movie playback system.

FIG. 2 shows an example of display on a touch panel screen 340.

FIG. 3 is a drawing for describing the process of step S603.

FIG. 4 is a flowchart of video playback processing executed by an image display apparatus 300.

FIG. 5 is a drawing for describing the process of step S604.

FIG. 6 is a drawing for describing the process of step S604.

FIG. 7 is a flowchart of video playback processing executed by the image display apparatus 300.

FIG. 8 is a drawing for describing the process of step S805.

FIG. 9 is a drawing for describing the process of step S805.

FIG. 10 is a flowchart of video playback processing executed by the image display apparatus 300.

FIG. 11 is a drawing for describing a third embodiment.

FIG. 12 is a block diagram showing an example of a hardware configuration of a computer apparatus.

### DESCRIPTION OF THE EMBODIMENTS

The following describes the embodiments of the present invention with reference to the attached drawings. Note that the following embodiments represent examples of specific implementations of the present invention, and a part of specific working examples of the configurations described in the claims.

### First Embodiment

In the present embodiment, a description will be given of an example of a control apparatus that: displays a timeline indicating image capture periods of recorded videos captured by a plurality of image capturing devices, as well as a movie that is decided on in accordance with an operation on the timeline, on a display screen; accepts an operation on the display screen; and when the operation on the display screen accepted during display of a first movie captured by a first image capturing device included among the plurality of image capturing devices indicates a predetermined direction different from a time direction of the timeline, switches the movie displayed on the display screen from the first movie to a second movie captured by a second image capturing device. More specifically, in the present embodiment, a movie playback system including such a control apparatus will be described as an example.

In the present embodiment, a flick operation denotes an operation of moving a finger or a pointer on the display screen from a designated starting point in an arbitrary direction. The pointer may be an indicator, such as a pen, or may be a pointer that is electronically displayed on the display screen and positionally moved on the display screen in accordance with a mouse operation or the like. The present invention can also be implemented using a swipe operation in place of the flick operation; the swipe operation inputs only an operation direction on the display screen without designating a starting point. The same goes for other embodiments described later.

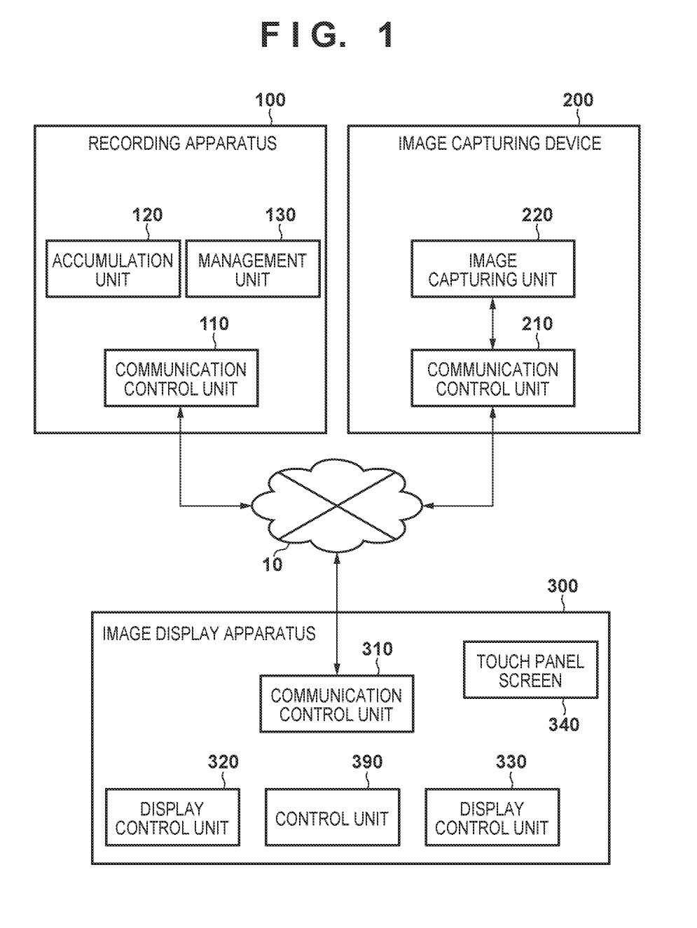

First, a description will be given of an example of a configuration of the movie playback system according to the present embodiment with reference to a block diagram of FIG. 1. As shown in FIG. 1, the movie playback system includes an image capturing device 200, a recording apparatus 100, and an image display apparatus 300 that serves as the control apparatus, and they are all connected to a network 10.

The image capturing device 200 will now be described. An image capturing unit 220 is a device that can capture a video (movie). A communication control unit 210 controls data communication with the recording apparatus 100 and the image display apparatus 300 via the network 10; for example, it transmits a video captured by the image capturing unit 220 to the recording apparatus 100 and the image display apparatus 300 via the network 10. Although one image capturing device 200 is connected to the network 10 in FIG. 1, it will be assumed hereinafter that a plurality of image capturing devices 200 are connected to the network 10.

Next, the recording apparatus 100 will be described. A communication control unit 110 controls data communication with the image capturing devices 200 and the image display apparatus 300 via the network 10; for example, it receives videos transmitted from the image capturing devices 200, and transmits various types of information to the image display apparatus 300.

The videos that the communication control unit 110 has received from the image capturing devices 200 have attribute information attached thereto, such as information unique to the devices that captured the videos (e.g., IDs and IP addresses), and information indicating the image capture start times and the image capture end times of the videos. Such attribute information is generated and attached to the videos by the transmission sources of the videos. The videos that the communication control unit 110 has received from the image capturing devices 200 are stored to an accumulation unit 120, whereas the attribute information attached to the videos is stored to a management unit 130. That is to say, the accumulation unit 120 stores the videos transmitted from the plurality of image capturing devices 200, whereas the management unit 130 stores the attribute information attached to the videos transmitted from the plurality of image capturing devices 200.

Note that the management unit 130 is not limited to storing only the attribute information attached to the videos, and may store information that has been generated by the recording apparatus 100 in relation to the videos, such as information indicating the events that triggered the recording of the videos.

The accumulation unit 120 is a memory device, such as a hard disk and a flash ROM. The videos are not limited to being recorded in the accumulation unit 120 in a particular recording format, and may be recorded therein in an H.264 format or the like. The management unit 130 is a memory device, such as a hard disk and a flash ROM. Although the accumulation unit 120 and the management unit 130 are discrete memory devices in FIG. 1, they may be integrated into a single memory device.

Although the image capturing devices 200 and the recording apparatus 100 are connected via the network 10 based on Ethernet (registered trademark) or the like in FIG. 1, they may be connected via any form of network, such as a network using an HDMI (registered trademark).

Next, the image display apparatus 300 will be described. A control unit 390 controls the entire operations of the image display apparatus 300; for example, it controls the operations of a communication control unit 310, a touch panel screen 340, a display control unit 320, and a display control unit 330 described below.

The touch panel screen 340 is a known device that can display various types of information under control by the display control units 320 and 330 described below, and detect a position touched by a fingertip of a user and a change in that position.

The communication control unit 310 controls data communication with the image capturing devices 200 and the recording apparatus 100 via the network 10; for example, it receives the videos captured by the image capturing devices 200 from the accumulation unit 120, and receives information corresponding to the videos captured by the image capturing devices 200 from the management unit 130.

The display control unit 320 plays back the videos received by the communication control unit 310 in chronological order (video playback order), starting with a video with the oldest image capture period (a period defined by the image capture start time and the image capture end time). The image capture period of each video is defined by the image capture start time and the image capture end time in the attribute information that the communication control unit 310 has received from the management unit 130 in relation to the video. That is to say, the display control unit 320 first plays back a video with the oldest image capture period on the touch panel screen 340 by displaying the frames thereof on the touch panel screen 340 in order, starting with the first frame. Upon completion of display of the last frame of this video, the display control unit 320 plays back a video with the second oldest image capture period on the touch panel screen 340 by displaying the frames thereof on the touch panel screen 340 in order, starting with the first frame. In this way, the videos received by the communication control unit 310 are played back in chronological order, starting with a video with the oldest image capture period.

The display control unit 330 generates a timeline from information of the videos that the communication control unit 310 has received from the management unit 130, and displays the generated timeline on the touch panel screen 340.

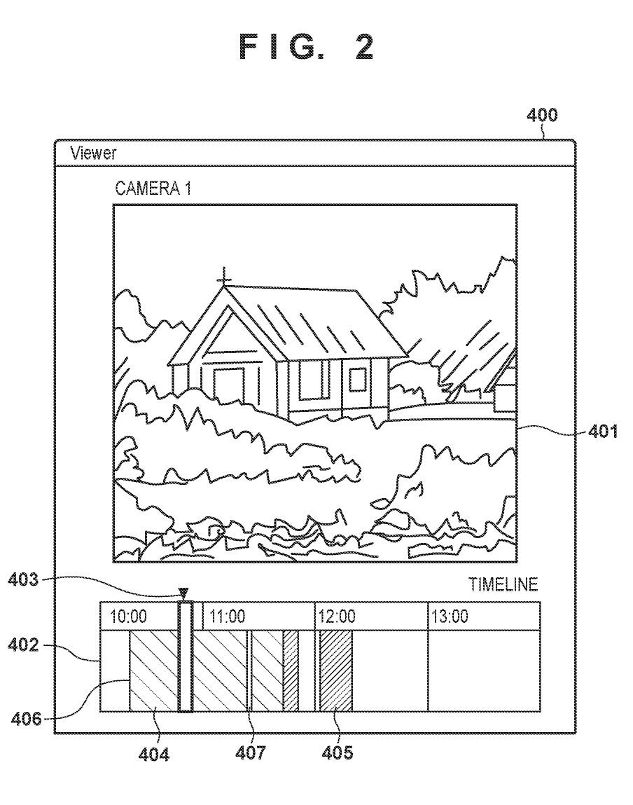

FIG. 2 shows an example of display performed by the display control units 320 and 330 on the touch panel screen 340. A window 400 is displayed on the touch panel screen 340, and the window 400 includes an area 401 for displaying the videos and an area 402 for displaying the timeline. This window 400 is generated by the display control units 320 and 330.

The videos played back by the display control unit 320 are displayed inside the area 401. The timeline generated by the display control unit 330 is displayed inside the area 402. The timeline of FIG. 2 is a bar-shaped image indicating time slots including the image capture start times and the image capture end times in the information of the videos that the communication control unit 310 has received from the management unit 130, and graphics indicating the image capture periods of the videos that the communication control unit 310 has received from the accumulation unit 120 are superimposed over the bar-shaped image. In FIG. 2, an image capture period of a video captured by one image capturing device 200, e.g., an image capturing device 200 with ID 1 (a section between the image capture start time 406 and the image capture end time 407 of this video (playback section)) is depicted as an image 404, and a playback section of a video captured by another image capturing device 200, e.g., an image capturing device 200 with ID 2 is depicted as an image 405. The images 404 and 405 may be displayed in any form as long as they can be distinguished from each other when presented. For example, they may have different colors, transparencies, or flashing patterns.

A marker 403 indicates, on the timeline, a position (playback position) corresponding to the image capture time of a frame that is currently displayed in the area 401. As time elapses, the image capture time of a frame displayed in the area 401 becomes more recent, and the marker 403 accordingly moves rightward. Note that the image capture periods of the videos may be presented by a list, a table, a bar graph, or the like in place of the timeline.

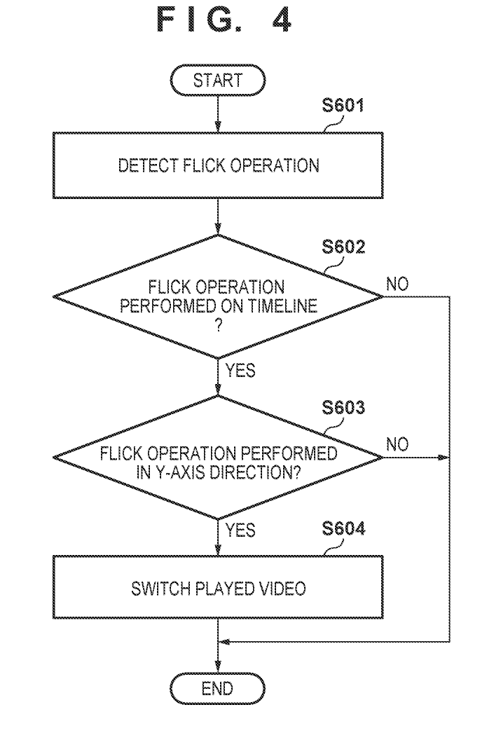

Next, video playback processing executed by the image display apparatus 300 will be described in line with a flowchart of FIG. 4.

<Step S601>

During playback of a video on the touch panel screen 340 as shown in FIG. 2, the control unit 390 monitors whether the user has performed a slide operation by touching the touch panel screen 340 with his/her finger, that is to say, whether the user has performed a flick operation on the touch panel screen 340. If the control unit 390 detects a flick operation during playback of a video on the touch panel screen 340, the processing proceeds to step S602.

<Step S602>

The control unit 390 determines whether the flick operation detected in step S601 was performed inside the area of the timeline (on timeline display). For example, when a touch operation performed inside the area of the timeline is followed by a movement of the fingertip without release of the fingertip from the touch panel screen 340, it is determined that “the flick operation detected in step S601 was performed inside the area of the timeline.”

If it is determined that the flick operation detected in step S601 was performed inside the area of the timeline, the processing proceeds to step S603; if it is determined that the flick operation detected in step S601 was performed outside the area of the timeline, the processing of the flowchart of FIG. 4 is ended.

<Step S603>

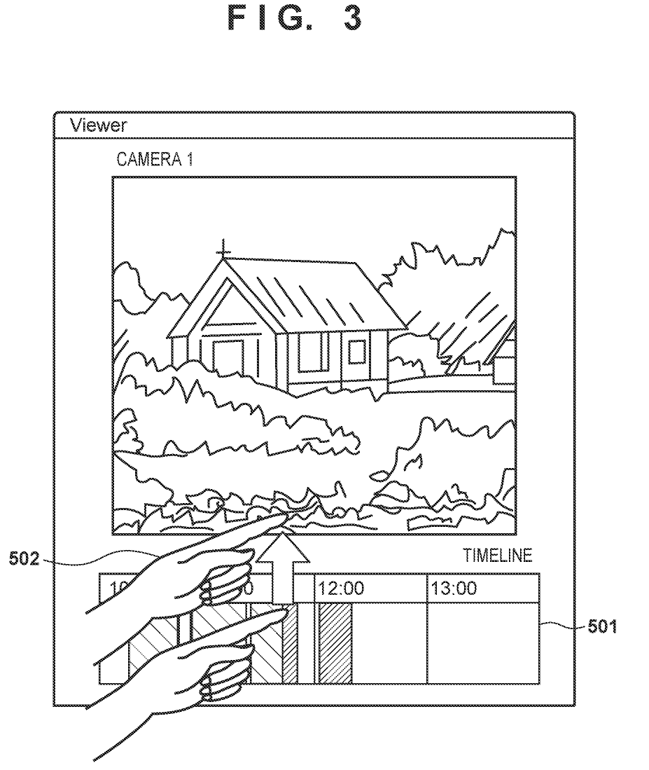

The control unit 390 determines whether the movement of the finger in the flick operation on the touch panel screen 340 includes a movement component toward an upper edge of the touch panel screen 340 or a movement component toward a lower edge of the same. For example, assume a case in which the position of the upper left corner of the touch panel screen 340 is (0,0), an x-axis is defined along a horizontal direction (where x increases toward the right side) and a y-axis is defined along a vertical direction (where y increases toward the lower side); in this case, if a y-component of a movement vector created by the fingertip in the flick operation is positive, it is determined that “the movement of the finger in the flick operation on the touch panel screen 340 includes a movement component toward the lower edge of the touch panel screen 340,” whereas if the y-component of the movement vector created by the fingertip in the flick operation is negative, it is determined that “the movement of the finger in the flick operation on the touch panel screen 340 includes a movement component toward the upper edge of the touch panel screen 340.” For example, as shown in FIG. 3, when the hand (finger) 502 of the user moves inside the area 501 of the timeline toward the upper edge of the touch panel screen 340 as indicated by an arrow, it is determined that the movement of the finger in the flick operation on the touch panel screen 340 includes a movement component toward the upper edge of the touch panel screen 340. Note that the y-component of the movement vector created by the fingertip in the flick operation is determined to be 0 if the value of the y-component falls within a predetermined range (−ε to ε, where ε is a sufficiently small positive value).

In the present step, any determination method may be used as long as the method enables a determination of whether the movement of the finger in the flick operation is toward the upper edge of the touch panel screen 340 or toward the lower edge of the same.

If it is determined that the movement of the finger in the flick operation on the touch panel screen 340 includes a movement component toward the upper edge of the touch panel screen 340 or a movement component toward the lower edge of the same, the processing proceeds to step S604; if it is determined that the y-component of the movement vector created by the fingertip in the flick operation is 0, the processing of the flowchart of FIG. 4 is ended.

<Step S604>

If it is determined that the movement of the finger in the flick operation on the touch panel screen 340 includes a movement component toward the lower edge of the touch panel screen 340, the control unit 390 controls the display control unit 320 to play back a certain video managed by the display control unit 320 as a video that is played back immediately after the currently played video on the touch panel screen 340 by displaying the frames of the certain video on the touch panel screen 340 in order, starting with the first frame. That is to say, playback of the currently played video is switched to playback of the certain video managed by the display control unit 320 as the video that is played back immediately after the currently played video.

On the other hand, if it is determined that the movement of the finger in the flick operation on the touch panel screen 340 includes a movement component toward the upper edge of the touch panel screen 340, the control unit 390 controls the display control unit 330 to play back a certain video managed by the display control unit 320 as a video that is played back immediately before the currently played video on the touch panel screen 340 by displaying the frames of the certain video on the touch panel screen 340 in order, starting with the first frame. That is to say, playback of the currently played video is switched to playback of the certain video managed by the display control unit 320 as the video that is played back immediately before the currently played video.

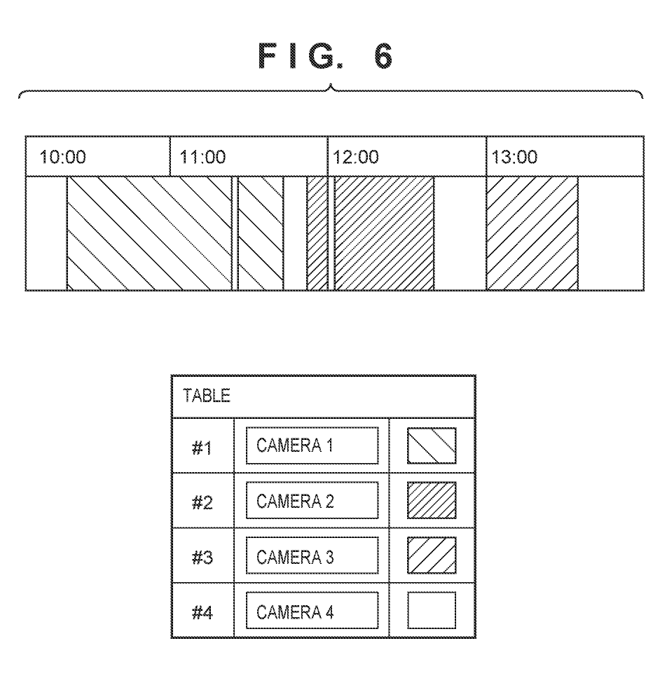

For example, assume a case in which the display control unit 320 manages videos in chronological order, starting with a video with the oldest image capture period, as shown in a table of FIG. 6 (that is to say, a video captured by a camera 1 (an image capturing device 200 with ID 1) has the oldest image capture period, a video captured by a camera 2 (an image capturing device 200 with ID 2) has the second oldest image capture period, a video captured by a camera 3 (an image capturing device 200 with ID 3) has the third oldest image capture period, and a video captured by a camera 4 (an image capturing device 200 with ID 4) has the most recent image capture period). During playback of the video captured by the camera 2, if the hand (finger) of the user moves inside the area of the timeline toward the lower edge of the touch panel screen 340, the video of the immediately following row in the table, that is to say, the video captured by the camera 3 is played back on the touch panel screen 340 by displaying the frames thereof on the touch panel screen 340 in order, starting with the first frame; if the hand (finger) of the user moves inside the area of the timeline toward the upper edge of the touch panel screen 340, the video of the immediately preceding row in the table, that is to say, the video captured by the camera 1 is played back on the touch panel screen 340 by displaying the frames thereof on the touch panel screen 340 in order, starting with the first frame.

In the case of FIG. 6, if the hand (finger) of the user moves inside the area of the timeline toward the upper edge of the touch panel screen 340 during playback of the video captured by the camera 1, the video of the lowermost row in the table, that is to say, the video captured by the camera 4 is played back on the touch panel screen 340 by displaying the frames thereof on the touch panel screen 340 in order, starting with the first frame.

On the other hand, in the case of FIG. 6, if the hand (finger) of the user moves inside the area of the timeline toward the lower edge of the touch panel screen 340 during playback of the video captured by the camera 4, the video of the uppermost row in the table, that is to say, the video captured by the camera 1 is played back on the touch panel screen 340 by displaying the frames thereof on the touch panel screen 340 in order, starting with the first frame.

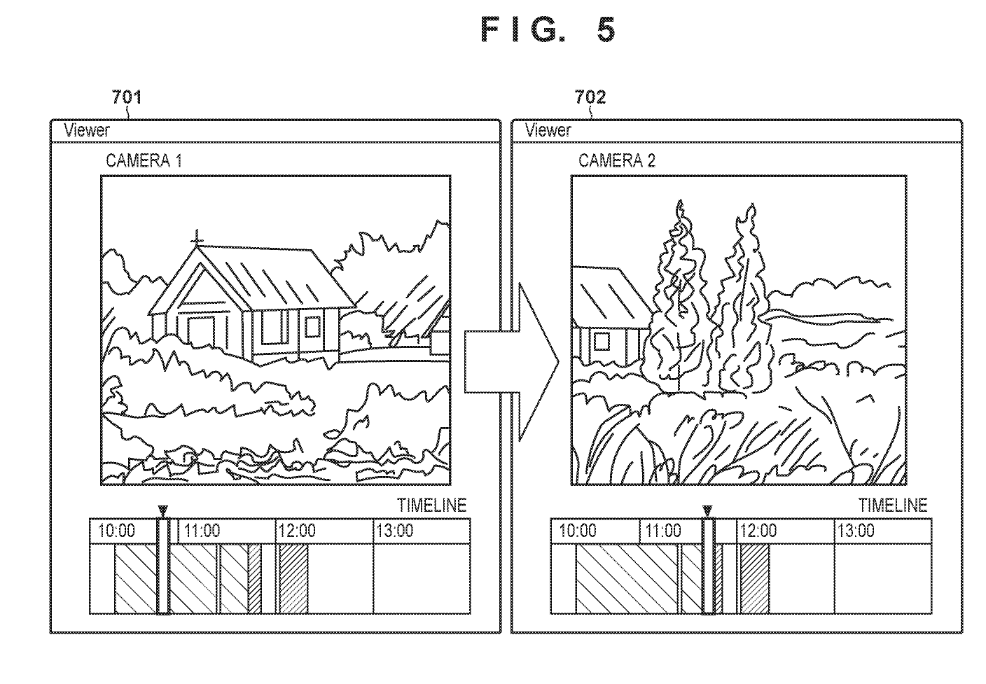

In FIG. 5, the hand (finger) of the user moves inside the area of the timeline toward the lower edge of the touch panel screen 340 during playback of the video captured by the camera 1 as indicated by 701, and subsequently, the video captured by the camera 2 is played back on the touch panel screen 340 by displaying the frames thereof on the touch panel screen 340 in order, starting with the first frame, as indicated by 702.

In accordance with the change in the video playback position, the display control unit 320 changes the position of the marker 403. For example, when playback of the video captured by the camera 1 is switched to playback of the video captured by the camera 2, the current position of the marker 403 is moved to the position of the first frame of the video captured by the camera 2.

### Second Embodiment

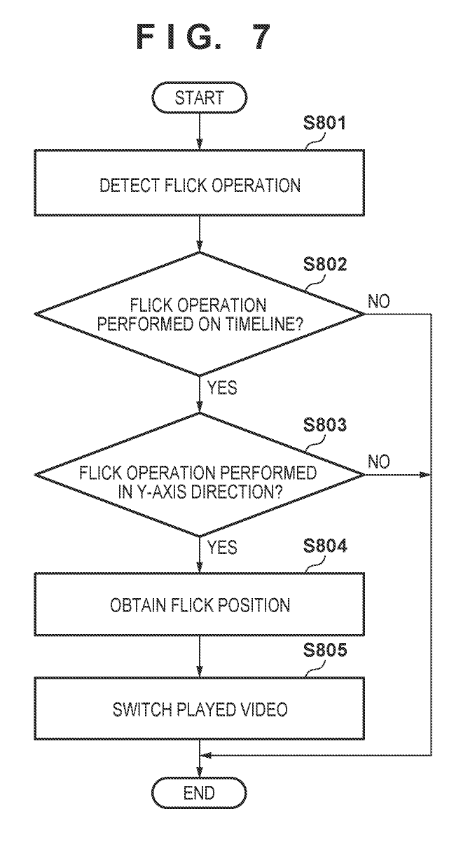

In the following description, the differences from the first embodiment will be focused, and it will be assumed that the present embodiment is similar to the first embodiment unless specifically mentioned. Video playback processing executed by the image display apparatus 300 will now be described in line with a flowchart of FIG. 7. Note that the processes of steps S801 to S803 are similar to those of steps S601 to S603 in FIG. 4, and thus a description thereof is omitted.

<Step S804>

The control unit 390 obtains the value of the x-coordinate of the position at which the flick operation was performed in the area of the timeline (the position that was first touched in the flick operation), and obtains the image capture time corresponding to the obtained value of the x-coordinate on the timeline. That is to say, it identifies the position corresponding to the image capture time that was touched by the user among the image capture periods indicated by the timeline.

Although the present embodiment is described using an example in which the user touches the screen, the finger and the screen need not necessary be in contact with each other. A touch may be detected when the distance between the finger of the user or the indicator and the display screen is smaller than a threshold.

<Step S805>

The control unit 390 controls the display control unit 320 to play back a video with an image capture period including the image capture time identified in step S804 on the touch panel screen 340 by displaying the frames thereof on the touch panel screen 340 in order, starting with the first frame. That is to say, playback of the currently played video is switched to playback of the video with the image capture period including the image capture time identified in step S804.

Here, “the video with the image capture period including the image capture time identified in step S804” denotes one of the videos whose image capture period defined by the image capture start time and the image capture end time “includes the image capture time identified in step S804.”

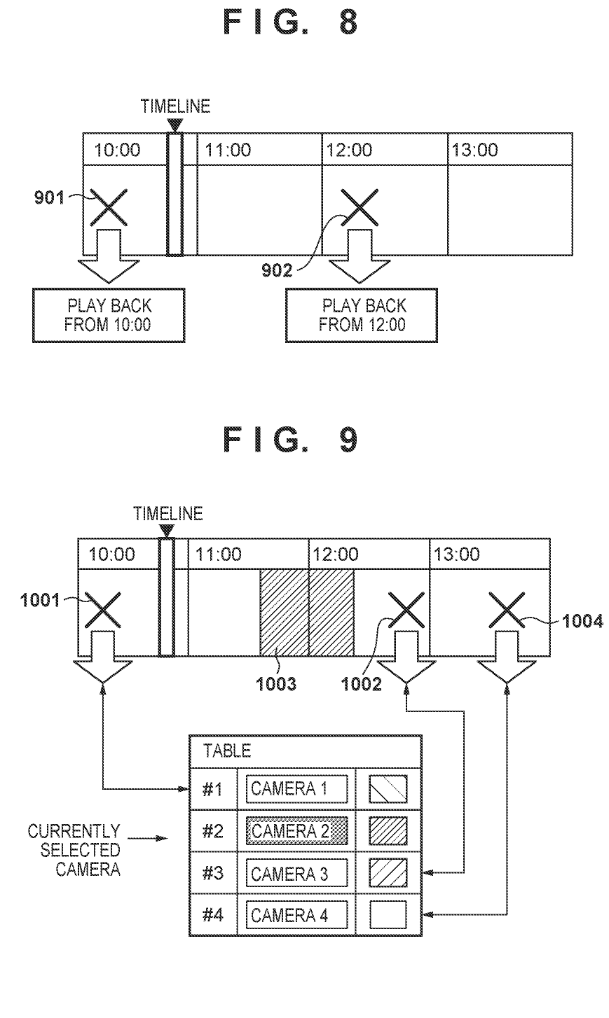

Referring to an example of FIG. 8, if the user performs a flick operation by touching a position 901, the frames of a video with an image capture period including the image capture time corresponding to the position 901 are played back in order, starting with the first frame (the frame at 10:00). On the other hand, if the user performs a flick operation by touching a position 902, the frames of a video with an image capture period including the image capture time corresponding to the position 902 are played back in order, starting with the first frame (the frame at 12:00).

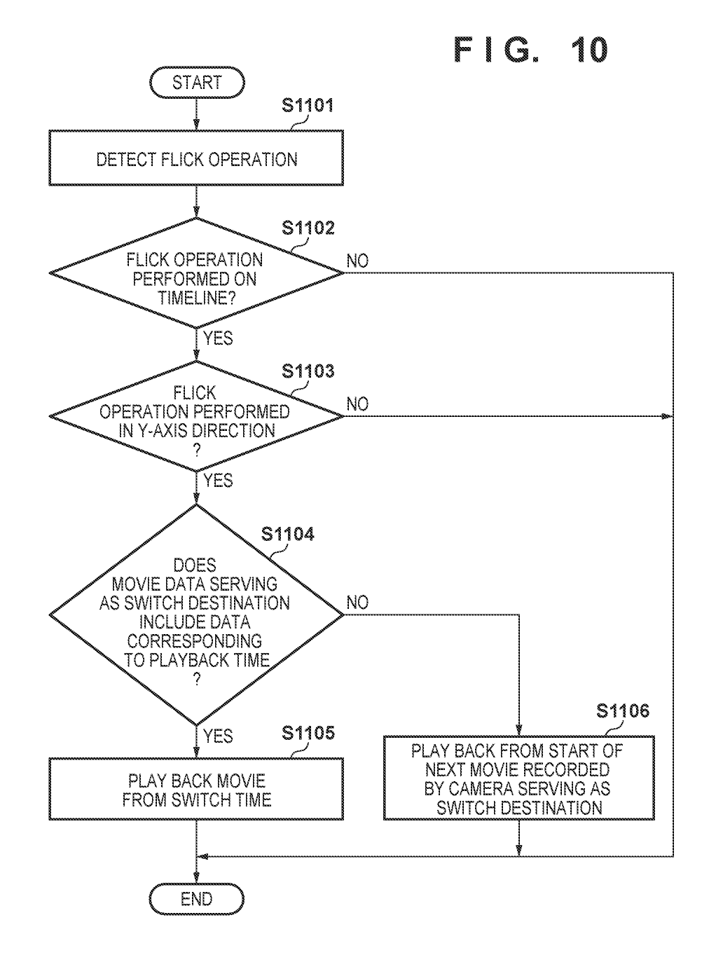

In the present embodiment also, the videos are managed in chronological order, starting with a video with the oldest image capture period, as shown in FIG. 9. For example, during playback of a video captured by the camera 2 (with an image capture period 1003), if the user performs a flick operation by touching a position 1001, the frames of a video with an image capture period including the image capture time corresponding to the position 1001 (a video captured by the camera 1) are played back in order, starting with the first frame. If the user performs a flick operation by touching a position 1002, the frames of a video with an image capture period including the image capture time corresponding to the position 1002 (a video captured by the camera 3) are played back in order, starting with the first frame. If the user performs a flick operation by touching a position 1004, the frames of a video with an image capture period including the image capture time corresponding to the position 1004 (a video captured by the camera 4) are played back in order, starting with the first frame.

Other methods can be used to select a video serving as a switch destination in accordance with the position touched to perform a flick operation. For example, if the position touched to perform the flick operation is on the left of the central position of the timeline (in an x-axis direction), the video immediately preceding the currently played video in the table may be selected as the switch destination (provided that the video of the uppermost row in the table is currently played back, the video of the lowermost row in the table is selected); if the position touched to perform the flick operation is on the right of the central position of the timeline (in the x-axis direction), the video immediately following the currently played video in the table may be selected as the switch destination (provided that the video of the lowermost row in the table is currently played back, the video of the uppermost row in the table is selected). Furthermore, for example, it is permissible to equally divide the area of the timeline by the number of image capturing devices, and switch to a video captured by an image capturing device corresponding to a divided area including the position touched to perform the flick operation.

### Third Embodiment

In the present embodiment, a description will be given of the movie playback system for a case in which some of the videos captured by the image capturing devices have overlapping image capture periods. In this case, the display control unit 320 manages the videos having overlapping image capture periods in a predetermined order. For example, when an image capture period of a video B is included within an image capture period of a video A, the video A and the video B may be managed in this order, or in the reverse order.

In the following description, the differences from the first embodiment will be focused, and it will be assumed that the present embodiment is similar to the first embodiment unless specifically mentioned. Video playback processing executed by the image display apparatus 300 will now be described in line with a flowchart of FIG. 10. Note that the processes of steps S1101 to S1103 are similar to those of steps S601 to S603 in FIG. 4, and thus a description thereof is omitted.

<Step S1104>

The control unit 390 determines whether the group of videos that the communication control unit 310 has received from the accumulation unit 120 includes a video with an image capture period including “the image capture time corresponding to a frame that was played back at the time of detection of the flick operation (the image capture time indicated by the marker 403 at that time)” (hereinafter referred to as the switch time). If it is determined that the group of videos includes a video with an image capture period including the switch time, the processing proceeds to step S1005; if it is determined that the group of videos does not include a video with an image capture period including the switch time, the processing proceeds to step S1006.

<Step S1105>

The control unit 390 controls the display control unit 320 to display the frames of the video with the image capture period including the switch time on the touch panel screen 340 in order, starting with a frame corresponding to the switch time.

<Step S1106>

The control unit 390 controls the display control unit 320 to display the frames of a video managed by the display control unit 320 as a video that is played back immediately after the currently played video on the touch panel screen 340 in order, starting with the first frame.

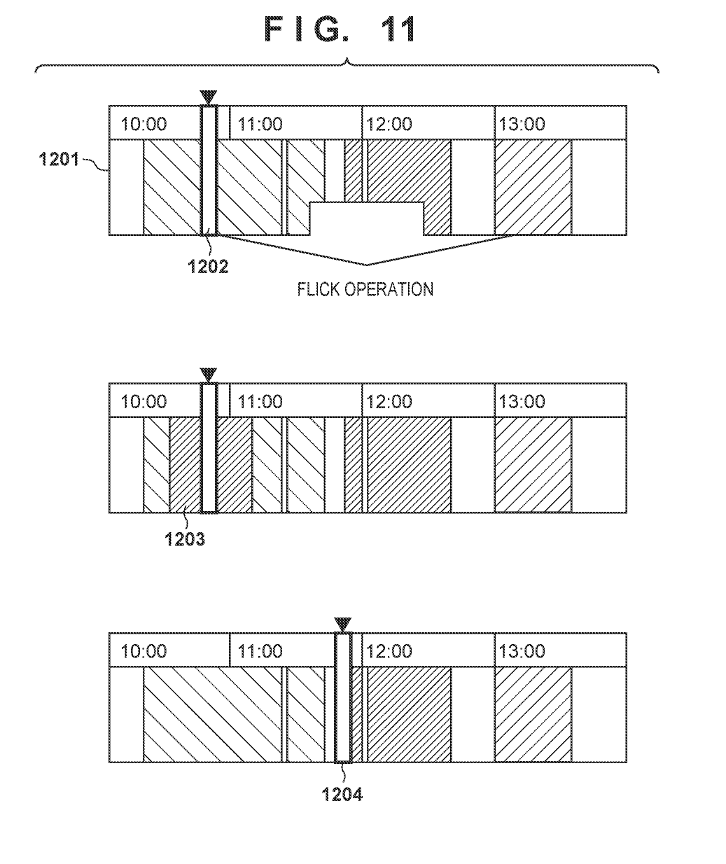

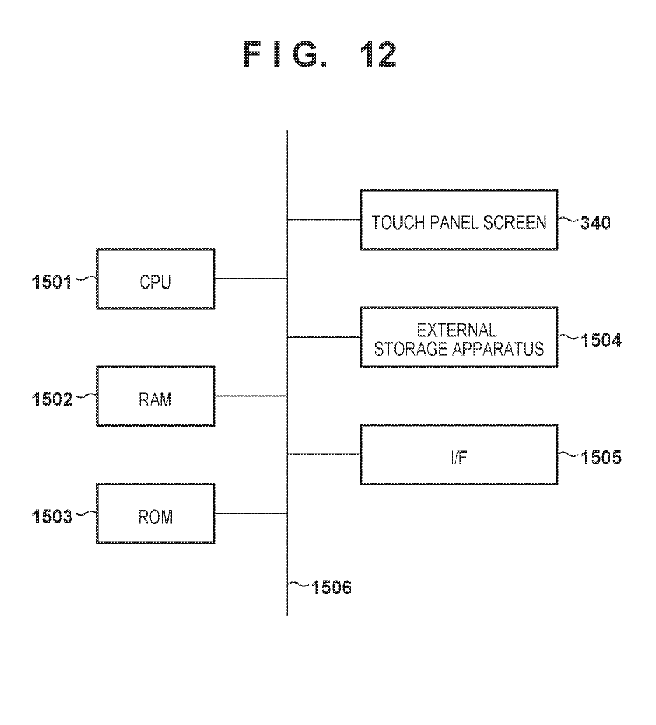

An example of the present embodiment will now be described using FIG. 11. Assume a case in which a flick operation is performed at a position 1202 on a timeline 1201 as shown in the top tier of FIG. 11; in this case, if there is a video 1203 with an image capture period including the image capture time corresponding to the position 1202 as shown in the middle tier of FIG. 11, current playback is switched to playback of the video 1203, starting with its frame at the image capture time corresponding to the position 1202 of the flick operation. On the other hand, if there is no video with an image capture period including the image capture time corresponding to the position 1202 as shown in the bottom tier of FIG. 11, current playback is switched to playback of a video that is managed to be played back immediately after the currently played video, from the start 1204 of the video.

Note that a video serving as a switch destination may be decided on based on the order registered with the aforementioned table, or a video with the closest image capture period may be decided on as the switch destination.

Although the videos are captured by different image capturing devices in the first to third embodiments, the videos may be captured by the same image capturing device, or some of the videos may be captured by the same image capturing device. That is to say, a video captured by the same image capturing device as the currently played video (a video with a playback section different from a playback section of the currently played video) may serve as the switch destination, or a video captured by an image capturing device different from an image capturing device that has captured the currently played video may serve as the switch destination.

### Fourth Embodiment

Although each of the functional components of the image display apparatus 300 shown in FIG. 1 may be constituted by hardware, the display control units 320 and 330 may be constituted by software (computer program). In this case, the computer program is installed in a computer apparatus that includes the control unit 390, the communication control unit 310, and the touch panel screen 340 as hardware, and the control unit 390 executes the installed computer program; this allows the computer apparatus to execute the aforementioned processing executed by the image display apparatus 300.

A description is now given of an example of a hardware configuration of such a computer apparatus using a block diagram of FIG. 12. Note that the functional components in FIG. 12 that are the same as the functional components in FIG. 1 are given the same reference numerals thereas, and a description thereof is omitted.

A CPU 1501 functions as the control unit 390 in FIG. 1, and executes processing using the computer program and data stored in a RAM 1502 and a ROM 1503 to control the entire operations of the computer apparatus and execute the aforementioned processing executed by the image display apparatus 300 that uses the computer apparatus.

The RAM 1502 has an area for storing the computer program and data loaded from an external storage apparatus 1504 and data received via an I/F 1505, and a working area used when the CPU 1501 executes various types of processing. As such, the RAM 1502 can provide various types of areas as appropriate.

The ROM 1503 stores, for example, setting data and a boot program for the computer apparatus.

The external storage apparatus 1504 is a large-capacity information storage apparatus, a typical example being a hard disk drive apparatus. The external storage apparatus 1504 stores an operating system (OS), as well as the computer program and data for causing the CPU 1501 to execute the aforementioned processing executed by the image display apparatus 300. The computer program includes a computer program for causing the CPU 1501 to execute the functions of the display control units 320 and 330. The data includes information that has been described earlier as known information. The stated computer program and data stored in the external storage apparatus 1504 are loaded to the RAM 1502 as appropriate under control by the CPU 1501, and executed by the CPU 1501.

The I/F 1505 functions as the aforementioned communication control unit 310, and performs data communication with the image capturing devices 200 and the recording apparatus 100 via the network 10.

The CPU 1501, RAM 1502, ROM 1503, touch panel screen 340, external storage apparatus 1504, and I/F 1505 are all connected to a bus 1506.

Although an ordinary personal computer (PC) may be used as the foregoing computer apparatus, an apparatus with a limited display area, such as a viewer for a mobile terminal, is especially suitable as the foregoing computer apparatus. Where appropriate, the aforementioned embodiments may be combined, in part or in whole, to be implemented.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-061666, filed Mar. 24, 2015, which is hereby incorporated by reference herein in its entirety.

What is claimed is:

1. A control apparatus, comprising:
a display control unit configured to control to display a timeline and a movie on a display screen, the timeline indicating image capture periods of recorded videos captured by a plurality of image capturing devices, and the movie being decided on in accordance with an operation on the timeline;
an accepting unit configured to accept an operation on the display screen; and
a switching unit configured to, when the operation on the display screen accepted by the accepting unit during display of a first movie captured by a first image capturing device included among the plurality of image capturing devices indicates a predetermined direction different from a time direction of the timeline, switch the movie displayed on the display screen from the first movie to a second movie captured by a second image capturing device.

2. The control apparatus according to claim 1, wherein
upon detection of an operation of moving a designated position from a position on the timeline toward an upper edge or a lower edge of the timeline during display of the first movie, the switching unit switches the movie displayed on the display screen from the first movie to the second movie.

3. The control apparatus according to claim 1, wherein
upon detection of an operation of moving a designated position from a position on the timeline in the time direction during display of the first movie, the switching unit switches the movie displayed on the display screen to a third movie that has been captured by the first image capturing device and is different from the first movie in an image capture period.

4. The control apparatus according to claim 1, wherein
upon detection of an operation of moving a designated position from a position on the timeline in the predetermined direction during display of the first movie, the switching unit switches the movie displayed on the display screen to the second movie that has been captured by the second image capturing device in an image capture period that overlaps an image capture period of the first movie.

5. The control apparatus according to claim 1, wherein
the display control unit performs control to play back a movie with an image capture period including time indicated by a position designated on the timeline, from a start of the movie.

6. The control apparatus according to claim 1, wherein
the display control unit performs control to play back a movie with an image capture period including time indicated by a position designated on the timeline, starting with a frame of the movie corresponding to the designated position.

7. The control apparatus according to claim 4, wherein
when there is no movie corresponding to the designated position on the timeline, the switching unit switches the movie displayed on the display screen from the first movie to a movie that immediately follows the first movie in an order based on the image capture periods.

8. The control apparatus according to claim 1, wherein
the operation accepted by the accepting unit includes a flick operation or a swipe operation.

9. The control apparatus according to claim 1, wherein
upon detection of an operation of moving a designated position from a first position on the timeline in the predetermined direction different from the time direction of the timeline during display of the first movie, the switching unit switches the movie displayed on the display screen from the first movie to the second movie captured by the second image capturing device, and
upon detection of an operation of moving the designated position from a second position that is on the timeline and different from the first position in the predetermined direction different from the time direction of the timeline during display of the first movie, the switching unit switches the movie displayed on the display screen from the first movie to a third movie captured by a third image capturing device different from the second image capturing device.

10. A control method, comprising:
controlling to display a timeline and a movie on a display screen, the timeline indicating image capture periods of recorded videos captured by a plurality of image capturing devices, and the movie being decided on in accordance with an operation on the timeline;
accepting an operation on the display screen; and
when the operation on the display screen accepted during display of a first movie captured by a first image capturing device included among the plurality of image capturing devices indicates a predetermined direction different from a time direction of the timeline, switching the movie displayed on the display screen from the first movie to a second movie captured by a second image capturing device.

11. A non-transitory computer-readable storage medium storing a computer program for causing a computer to function as:
a display control unit configured to control to display a timeline and a movie on a display screen, the timeline indicating image capture periods of recorded videos captured by a plurality of image capturing devices, and the movie being decided on in accordance with an operation on the timeline;
an accepting unit configured to accept an operation on the display screen; and
a switching unit configured to, when the operation on the display screen accepted by the accepting unit during display of a first movie captured by a first image capturing device included among the plurality of image capturing devices indicates a predetermined direction different from a time direction of the timeline, switch the movie displayed on the display screen from the first movie to a second movie captured by a second image capturing device.
